(19) United States
(12) Patent Application Publication
(10) Pub. No.: US 2008/0010343 A1
(43) Pub. Date: Jan. 10, 2008

(54) METHOD OF PROVIDING A DIGITAL ATHLETE PROFILE

(75) Inventors: Carlos A. Escaffi, Finksburg, MD (US); Edward F. Kelley III, Ellicott City, MD (US); Richard Toland, Columbia, MD (US); Lawrence Gary, Clifton, VA (US)

Correspondence Address: DUANE MORRIS, LLP;IP DEPARTMENT, 30 SOUTH 17TH STREET, PHILADELPHIA, PA, 19103-4196, US

(73) Assignee: DIGITAL SPORTS, INC., Columbia, MD (US)

(21) Appl. No.: 11/752,732

(22) Filed: May 23, 2007

Related U.S. Application Data
(60) Provisional application No. 60/802,796, filed on May 24, 2006.

(51) Int. Cl. G06F 15/16

(52) U.S. Cl. 709/204

(57) ABSTRACT

A method of developing an internet sports social network web page with advertising, having the steps of accumulating a community based database of athlete or activities information, determining an advertising section profile for the web page based on the accumulated database; and preparing the network web page based on the database accumulated.

### CROSS-REFERENCE TO RELATED APPLICATIONS

The present application claims priority under 35 U.S.C. § 119(e) to U.S. Provisional Patent Application 60/802,796 filed on May 24, 2006, the entirety of which is incorporated by reference herein.

### FIELD OF THE INVENTION

The present invention relates to a method of providing a sports network portal. More specifically, the present invention provides a method of providing a sports network portal that allows creation of web pages based upon a community based database related to youth sports athletics, and activities.

### BACKGROUND INFORMATION

As the use of the internet has grown, creation of social networks for individuals having a similar background/hobby has increased. However, creation of social networks via the internet, that are directed to the youth sports or club sports sector, has not occurred. Social networks currently created on the internet do not display personalized athletic or activities information pertaining to local sports, or youth activities that are customizable by the users themselves. The lack of such a social network causes advertisers to miss advertising opportunities for prospective buyers pertaining to specific users.

Accordingly, there is a need for a method to provide a web portal that creates and displays web pages that allow a user to customize the web page and provide for social networking for youth sports, club sports, and school or community activities as well as allow for targeted advertising.

### SUMMARY OF THE INVENTION

The invention meets the foregoing need and provides a method for creating a web portal that creates and displays web pages that allow a user to customize the web pages and provide for social networking of athletes. The present invention provides a method for developing an internet sports social network web page with advertising, comprising the steps of accumulating a community based database of athlete information; determining an advertising section profile for the web page based on the accumulated database, and preparing the network web page based on the database accumulated, wherein a portion of the web page comprises at least an advertising section based on the advertising section profile and wherein a second portion of the web page comprises at least one of chat sections, a contacts section, a discussions section, an events calendar and an announcements section, and a third portion of the web page comprises a database profile section and at least one of a news feed section, a sponsor advertisement section, and a gallery section. The method may be accomplished such that the advertising section is related to a same sport provided in the digital athlete profile section. The method may further comprise providing a site navigation section that allows navigational control of a users view of the page. Furthermore, the method may be accomplished such that the advertising section is at least one of an advertising banner, a video recording and an audio recording. The contacts section may display at least one of a name, email address and telephone number of the athlete for an authorized user. The news feed section may contain information related to a sport provided in the digital athlete profile section. The method may also further comprise the step of including a sponsor portion configured for advertising to the user. The step of accumulating the database of athlete information is accomplished through accepting user input. The method may also be performed such that the user is registered. The method may also comprise the step of registering one of an athlete and a team for access to the web page before the step of accumulating the database of athlete information.

In the embodiments provided above, the digital athlete profile is configured to allow the user to customize the web page with personal information. The method may also be performed such that the step of registering the athlete requires an athlete to submit information to the database. The method may also further comprise the step of saving the internet sports social network web page. The method may also include the step of granting access to the internet sports social network web page for the athlete to individuals defined by the athlete. The digital athlete profile is configured to allow the athlete to upload at least one of photos and video into the web page. The method may also be accomplished such that at least one of the first, second and third portions of the web page is a separate scrollable window. The method may also be accomplished such that the discussions section of the web page requires authorization by the athlete.

Another exemplary embodiment of the present invention provides a method of creating an internet sports social network web page, comprising: registering a user for network access, accumulating a database of athletic information from the user, and preparing the web page based on information received from the accumulation of the database information from the user, wherein at least one portion of the web page is an athletic profile section.

The web page may include an advertising section based upon the database of the athletic information from the user. The method may also comprise saving the web page in a computer arrangement. The method may further comprise the step of granting access to the web page by the athlete to individuals defined by the athlete. The advertising section may be an advertising banner, a video replay or an audio replay.

Another exemplary embodiment of the present invention provides a method of creating an internet sports social network web page comprising preparing a web page template, the template having a digital athlete profile portion, a gallery portion and an advertising section, preparing a database of athletic information based on the template, and populating the template based upon the database of athletic information to form the web page.

This method may be accomplished such that the community database includes at least one of sports statistics, school information, athlete contact information, athletic biographical information, athlete academic information, athletics awards, athletic news, alumni information, and athletic pictures, game videos, highlight videos, coach recommendations, teacher recommendations, activities information, community service information. This method may comprise the steps of registering an individual to access the web page created, and displaying non-private sections of the web page created to the registered individual. The method may also be accomplished such that the registered individual is one of a college admissions director and a college coach.

The present invention also provides a method for creating an internet social network web page, comprising the steps of registering a user for network access, accumulating a community database of activities information from the user; and preparing the web page based on information received from the accumulation of the community database information from the user, wherein at least one portion of the web page is an activities profile section. The web page may include an advertising section based upon the community database of the activities profile information from the user. The method may also comprise granting access to the internet social network web page for the user with the activities profile to individuals defined by the user. The method may also be conducted such that the web page further comprises a sponsor portion configured for advertising to the user.

The method may also further comprise registering an individual to access the web page created, and displaying non-private sections of the web page created to the registered individual.

Additional features, advantages, and embodiments of the invention are set forth or are apparent from consideration of the following detailed description, drawings, and claims. It is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention.

FIG. 1 presents a first portion of a sports social networking portal in accordance with the present invention.

FIG. 2 presents a second portion of a sports social networking portal in accordance with the present invention.

FIG. 3 presents a third portion of a sports social networking portal in accordance with the present invention.

FIG. 4 presents a site menu for use with sports social networking portal shown in FIGS. 1 to 3.

FIG. 5 presents a digital athlete profile for use with the sports social networking portal shown in FIGS. 1 to 3.

FIG. 6 provides a method of developing an internet sports social network web page with advertising.

FIG. 7 provides a method of creating an internet sports social network web page.

FIG. 8 provides a method of creating an internet sports social network web page using a web page template, the template having a digital athlete profile portion.

FIG. 9 provides a method of creating an internet social network web page for digital activities.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description.

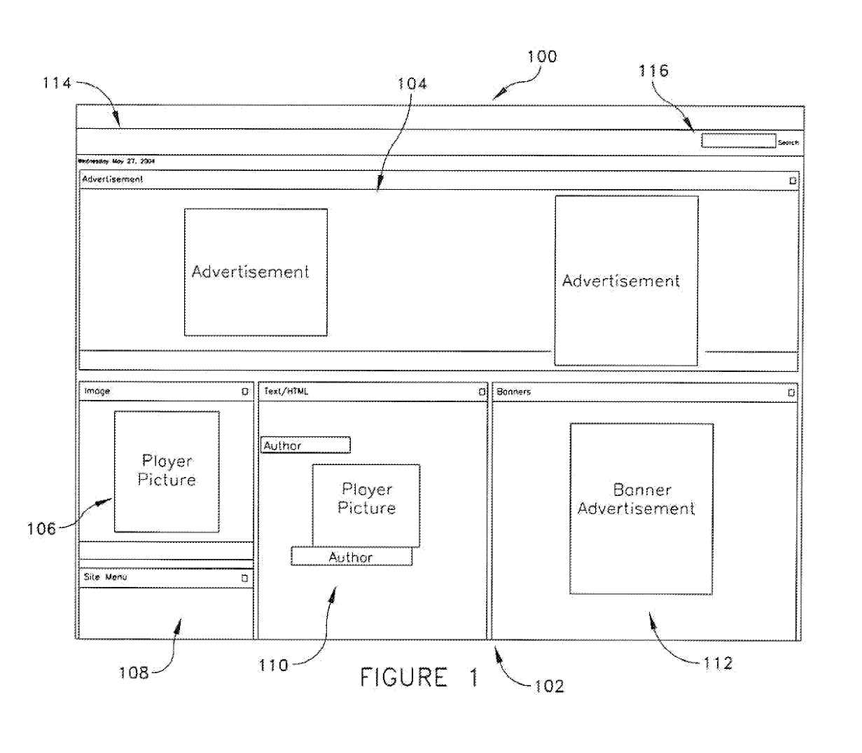

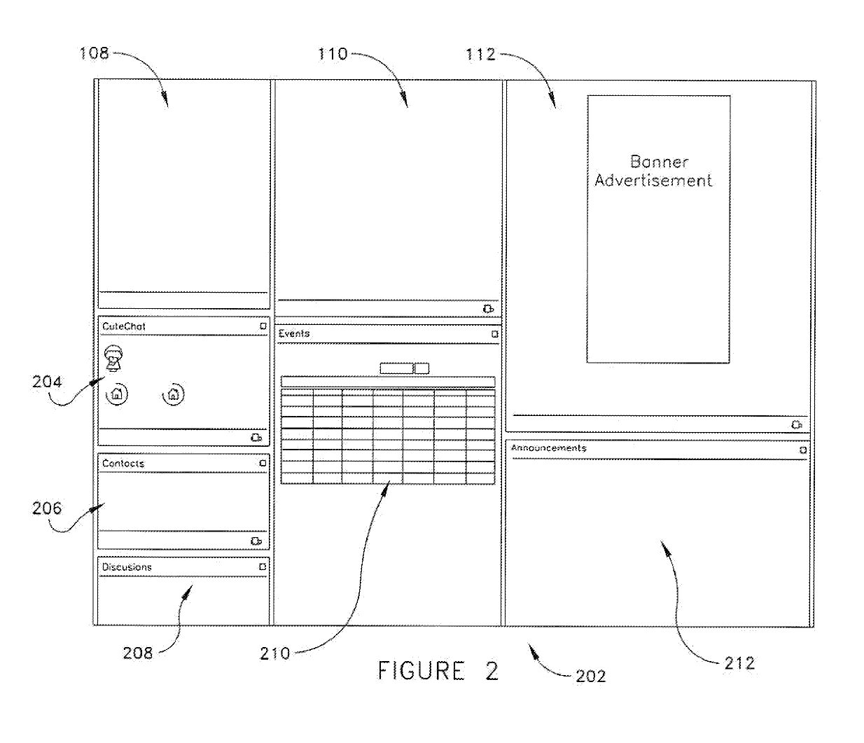

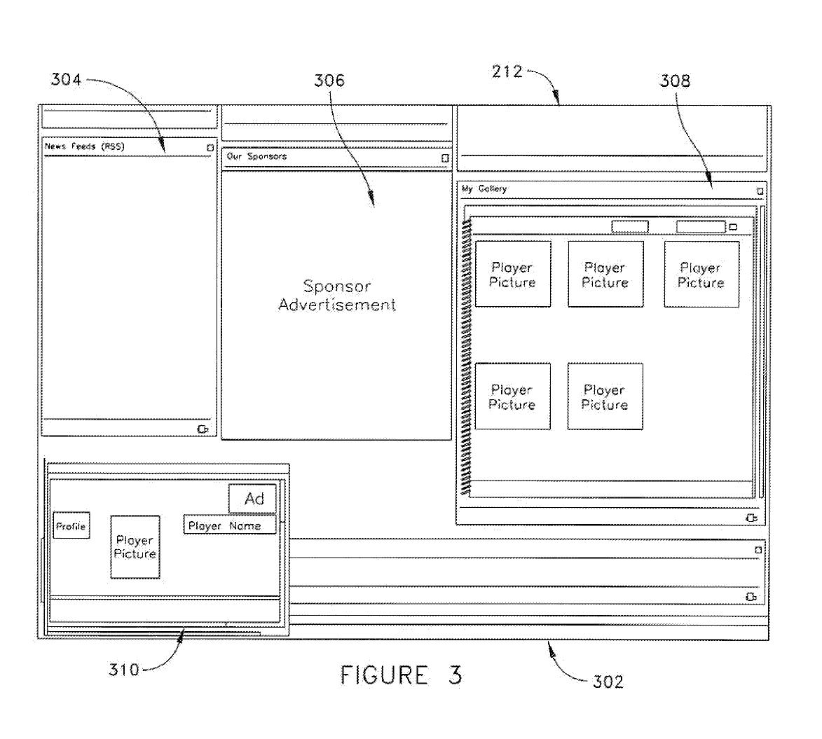

Referring to FIGS. 1-3, one embodiment of the invention comprises a sports social networking portal 100 that includes a first portal portion 102, a second portal portion 202, and a third portal portion 302. The entire portal 100 may also be referred to a vortol (vertical portal). More specifically, the sports social networking portal 100 may be implemented as an html-type web page or template that may be filled with data from a database. The sports social networking portal 100 includes the first portal portion 102 as shown in FIG. 1 that may be connected to the second portal portion 202 shown in FIG. 2, that in turn may be connected to a third portal portion 302 shown in FIG. 3. Accordingly, FIG. 1, FIG. 2, and FIG. 3 together form a complete web page that forms the sports social networking portal 100 web page. The portions 102, 202, 302 provided above may be separate pages, may operate together as shown, or take any other form known in the art.

Upper portal portion 102 includes an advertising section 104, e.g., an advertisement banner as a non-limiting example. Other examples of advertising sections 104 may be video and/or audio replays. The advertisements placed within advertisement section 104 may be, for example, focused directly on the type of sport and age group that is specific to the sport's social networking portal and information derived from the user or, alternatively could be focused on other demographics related to the sport's social networking portal and information derived from the user. Thus, when a registered user enters data into a database for portal 100, the type of sport that is entered by the user will allow the advertisement section 104 to be tailored to the entered sport type.

First portion 102 of portal 100 is customizable by each individual user to include an image of the user/athlete 106 of the specific web page. In this regard, the user/athlete uploads an image for his/her sport into a database and the image is used (such as by a pre-formed template) to build the web page. First portion 102 of the sports social networking portal 100 includes a site menu 108 shown partially in both FIG. 1 and FIG. 2. Sports social networking portal 100 further includes customizable text-based stories 110. Portal 100 includes navigation buttons 114 and a search capability via a search input portion 116 to allow users to have control of the web page. Banner advertisements 112 may also be displayed or audio or video advertisements, as provided in FIG. 1 and continued in FIG. 2.

FIG. 2 presents a second portion 202 of the sports social networking portal 100. In particular, FIG. 2 presents continuations of the site menu 108, in which text-based stories 110 and, e.g., banner advertisements 112 are provided. Additionally, the second portion 202 of the sports social networking portal 100 includes a chat section 204, a contacts section 206, a discussions section 208, an events calendar 210, and an announcements section 212. The chat section 204 of the generated web page allows a user to contact other users within the social network for discussion of topics. The chat section 204 may be word or video based. The contacts section 206 is populated from information provided by the user to the database.

FIG. 3 presents the third portal portion 302 of sports social networking portal 100. In particular, the third portal portion 302 may include a news feed section 304, a sponsor advertisement section 306, a “my gallery” section 308 and a My DAP (Digital Athlete Profile) section 310. Sports social networking portal 100 is often divided into three different sections, but may be one continuous section. The various sections and portions of sports social networking portal shown in FIGS. 1 to 3 can take any form and can be implemented in any known way. Moreover, the sports social networking portal does not need to include each and every section as described in conjunction with the exemplary embodiment of FIGS. 1 to 3. The portal may include less or additional features or portions.

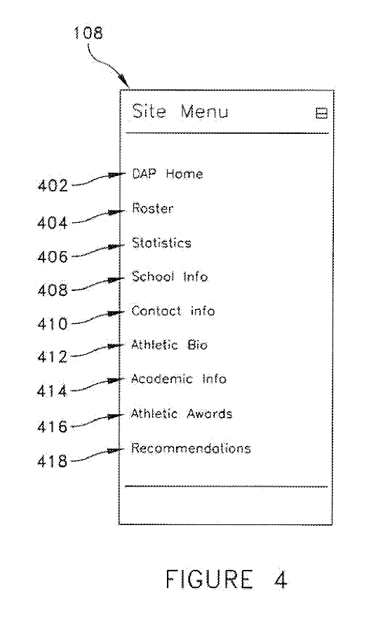

FIG. 4 presents the site menu 108 that includes hyperlinks to portions of sports social networking portal 100. In particular, hyperlink 402 directs a website user to the digital athlete profile section. The roster 404 link takes a web user to the roster of the various teams that are associated with the player of sports social networking portal 100. Hyperlink 406 links the website user to the statistics of the school, team, and/or player associated with the sports social networking portal 100. Contact information is obtained by hyperlink 410. The contact information may be based on the school, team, or player associated with sports social networking portal 100. The user/athlete's biography may be obtained by clicking on the athlete biography section 412 of the site menu 108. The athlete biography 412 provides various information with respect to the athlete. The academic information link 414 may provide academic information regarding the player. Hyperlink 416 may direct a user to the athlete's awards, school's awards, and/or team's awards. Finally, the recommendations hyperlink 418 of the site menu 108 may provide a user with various sports or academic-based recommendations for the student athlete.

The text-based story section 110, shown in FIG. 1, is provided by a user of sports social networking portal 100. In particular, a user may be able to upload pictures and/or text to provide a story-based and/or interest-based feature for sports social networking portal 100.

FIG. 2 illustrates the events calendar section 210 of sports social networking portal 100, which provides a user with the ability to enter information regarding practice schedules, team schedules, game schedules and other information. The events calendar 210 may have the ability to allow a coach to enter calendar information and allow the information to be migrated to each athlete's particular event calendar 210. Moreover, a parent may be able to enter information into the events calendar 210. A parent with multiple children participating in sports may be able to coordinate the various calendars of their children in order to coordinate the various sports schedules. This allows a parent to work with various schedule conflicts.

FIG. 2, as noted above, shows the chat feature 204 of sports social networking portal 100. In particular, the chat feature 204 allows the student-athlete to chat with fellow athletes, coaches, parents and the like regarding various needs, reminders, etc. Moreover, parents are able to chat with coaches and players to provide reminders, praise, and the like. Accordingly, both events calendar 210 and chat feature 204 allow two-way communication between parents, coaches and athletes. The contact feature 206 of sports social networking portal 100 allows a parent, coach, and/or athlete to add contact information to the web page regarding the parents, coaches, and/or athletes. This information may include name, position, email, telephone numbers or the like.

The discussions feature 208 allows coaches, parents, and athletes to start and/or engage in various discussions in sports-related matters. In this regard, both coaches and athletic directors may have access to sports social networking portal 100 to prevent inappropriate use. Moreover, the discussions portion 208 allows for communication with other invited student athletes. The content and the audience (limited access) may be limited to one degree or another as stipulated by the users and local regulations.

The student athlete may select various sports websites to provide a RSS type (Really Simple Syndication—(file format) which is a form of web syndication used by news websites and weblogs) of news feed to the news feeds portion 304. In this way, the student athlete's favorites teams or favorite news journals may be provided on his or hers own personalized sports social networking portal 100 web page.

The announcement section 212 may include various different coach, parent, advertisement-type announcements that are loaded into their respective databases. For example, ticket sales or other sports-related type of announcements may occur in the announcement section 212.

The “my gallery” portion 308 provides a user web page capability in which the user may upload various photographs and/or videos for viewing on the website of the sports social networking portal.

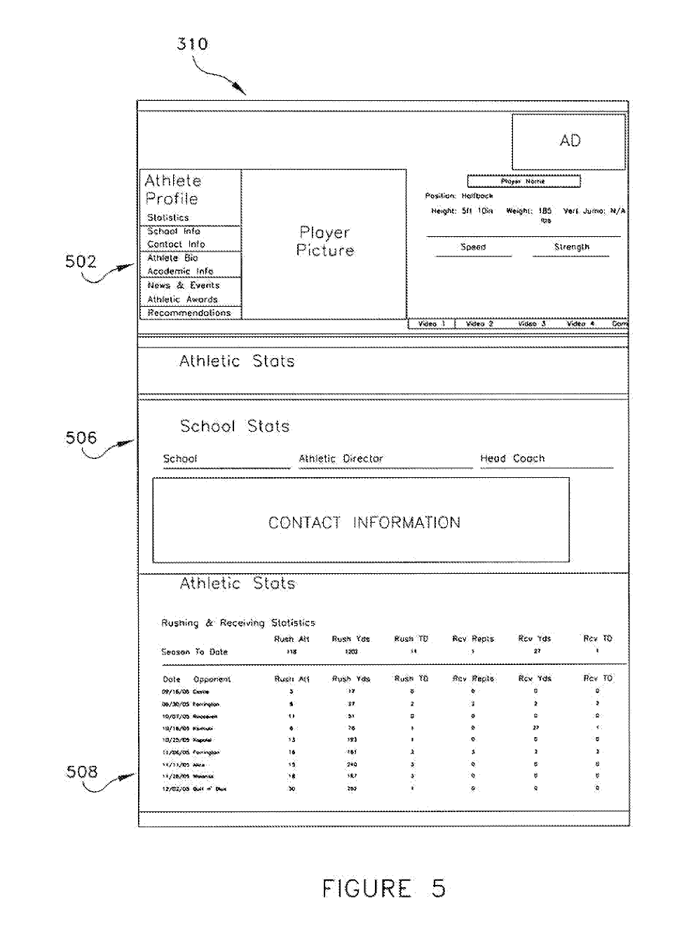

FIG. 5 shows the digital athlete profile section 310 that often includes a separate scrollable window within sports social networking portal 100. Alternatively, digital athlete profile 310 may be a separate web page or may be included in the web page of the athlete in sports social networking portal 100. The digital athlete profile shown in FIG. 5 includes, for example, an uploaded photograph of the student athlete, the student athlete's name and various sports-based criteria including height, weight, vertical jump, sports position, speed, strength and the like. Moreover, digital athlete profile section 310 may include one or more of statistics for the athlete, school information on the athlete, contact information for the athlete, the athlete's biography, academic information of the student athlete, news and events related to the athlete, the athlete's awards, and recommendations for the athlete in section 502. Moreover, digital athlete profile 310 may include the ability to upload various videos and game highlights 504. These highlights can include photographs (including photos, video highlights, game tapes, and the like) and also other various sports highlights for viewing by a user. The information that is provided to the digital athlete profile 310 may be gathered and tagged, i.e., uniquely associating this information with a particular person, sport, or activity, by various coaches, athletic directors, fans, players, interns, alumni and other people who are willing to accumulate the information (i.e., statistics, video, digital pictures, etc.) and upload it to the website. The digital athlete profile 310 will very often include information derived from a community database of athlete information that includes, but is not limited to sports and activities pertaining to high school sports and non-sport-related activities (e.g., theater, band, science club, etc.), middle school sports and non-sport-related activities, grammar school sports and non-sport-related activities as well as sports and non-sport-related activities that are not necessarily associated with or sponsored by a school district, e.g., youth league baseball, youth league football, youth league soccer, youth league basketball, youth league fencing, youth league bowling, youth league tennis, and similar adult league sports and activities, and other social activities that are based within one or more social communities.

The digital athlete's profile 310 allows college recruiters to review the athlete's resume including photos, video highlights, game tapes, statistics, academic achievements and extracurricular activities in order to consider the athlete for scholarships and the like. As further shown in FIG. 5, digital athlete's profile 310 may include school information as shown in section 506 and may also include various statistics in section 508 and the like. The digital athlete profile 310 may further include the ability for the athlete to personalize this particular portion. In particular, the athlete is able to provide or designate various screen backgrounds, music, sports memorabilia and the like to be associated with his or her profile 310 or “locker.”

Accordingly, sports social networking portal 100 provides a method in which a student athlete may generate and maintain a personalized sports-based web page that provides a vehicle for the student athlete to exhibit a personal expression within the sports niche or genre. Moreover, this personalized web page generated through a sports social networking portal 100 may be accessed by coaches, athletic directors, and by parents to prevent inappropriate use. The personalized web page found through this sports social networking portal 100 provides organizational tools for parents and players, communication systems and tools, personal expression, recruiting access and the like.

The social networking portal 100 may also be used also to form a digital activities profile. The digital activities profile may be for school activities or clubs not related to athletics but that require social networking for maximization of informational transfer. As the portal 100 may be configured for these activities, similar requirements provided above in relation to athletics may be instituted for students, for example, who are using the portal for digital activities, e.g., band, theater, art, public benefit or the like non-athletic activities.

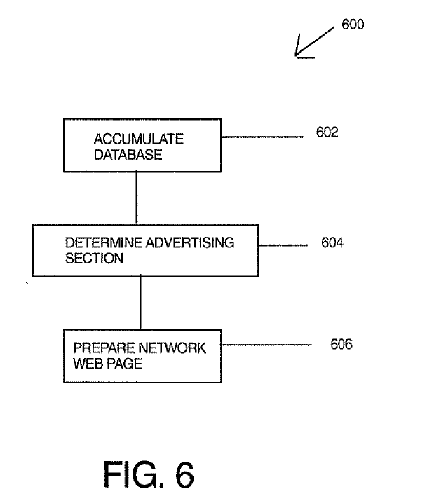

Referring to FIG. 6, a method 600 of developing an internet sports social network web page with advertising, in conjunction with the present invention is provided. The method comprises the steps of accumulating a community based database of athlete information 602, determining an advertising section profile for the web page based on the accumulated database 604 and preparing the network web page based on the database accumulated, wherein a first portion of the web page comprises at least an advertising section based on the advertising section profile and wherein a second portion of the web page comprises at least one of chat sections, a contacts section, a discussions section, an events calendar and an announcements section, and a third portion of the web page comprises a database profile section and at least one of a news feed section, a sponsor advertisement section, and a gallery section 606. It should be understood that the community database of athlete information includes, but is not limited to sports and activities pertaining to high school sports and non-sport-related activities, middle school sports and non-sport-related activities, grammar school sports and non-sport-related activities as well as sports and non-sport-related activities that are not necessarily associated with or sponsored by a school district, e.g., youth league baseball, youth league football, youth league soccer, youth league basketball, youth league fencing, youth league bowling, youth league tennis, and similar adult league sports and activities, and other social activities that are based within one or more social communities.

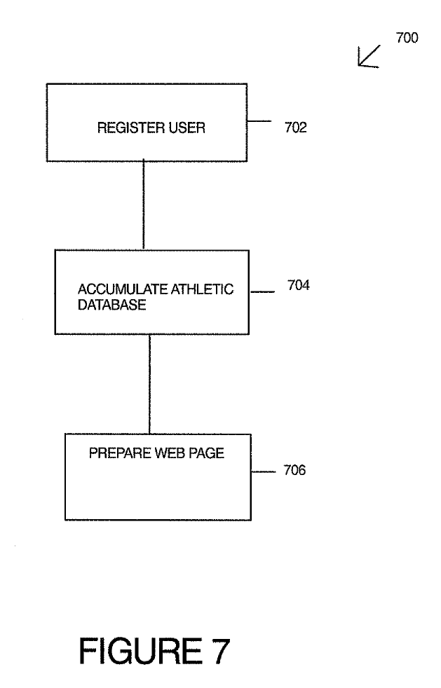

Referring to FIG. 7, an alternative embodiment of the invention provides a method for creating an internet sports social network web 700. Method 700 comprises registering a user for network access 702, accumulating a database of athletic information from a user 704, and preparing the web page based upon information received and accumulated in the database from the user, wherein at least one portion of the web page is an athletic profile section 706.

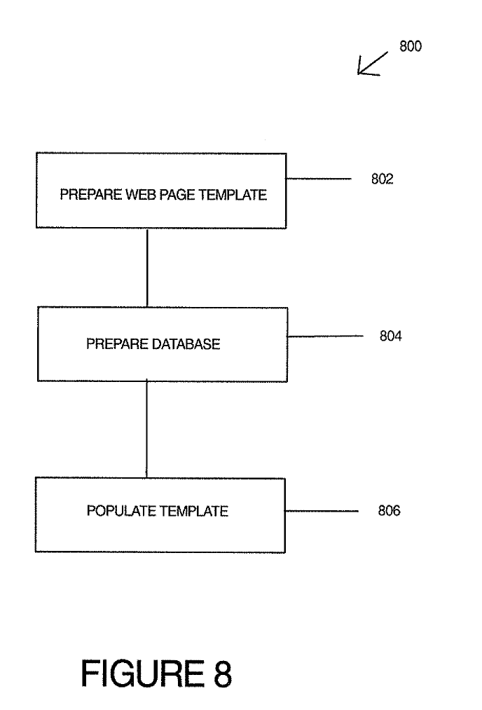

Referring to FIG. 8, a method 800 of creating an internet sports social network web page is provided having the steps of preparing a web page template 802, the template having a digital athlete profile portion, a gallery portion and an advertising section, preparing a database of athletic information based on template 804; and populating the template based upon the database of athletic information to form web page 806.

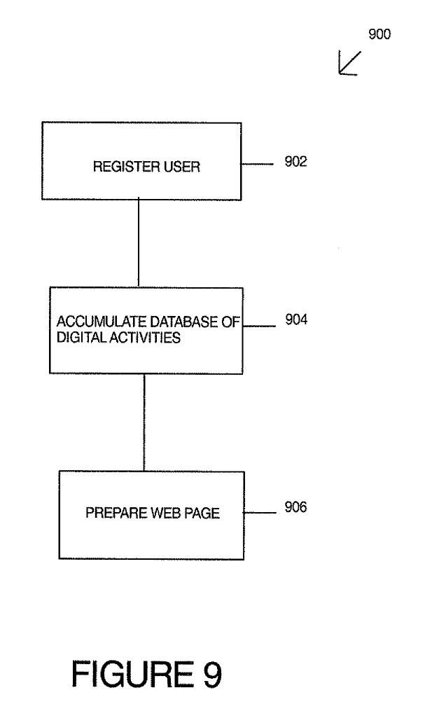

Referring to FIG. 9, a method 900 of creating an internet social network web page provides for the steps of registering a user for network access 902, accumulating a community database of digital activities information from a user 904, and preparing the web page based upon information received and accumulated in the community database from the user, wherein at least one portion of the web page is a digital activities profile section 906.

In the foregoing specification, the invention has been described with reference to specific exemplary embodiments. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A method for developing an internet sports social network web page with advertising, comprising:
accumulating a community based database of athlete information;
determining an advertising section profile for the web page based on the accumulated database; and
preparing the network web page based on the database accumulated, wherein a first portion of the web page comprises at least an advertising section based on the advertising section profile and wherein a second portion of the web page comprises at least one of chat sections, a contacts section, a discussions section, an events calendar and an announcements section, and a third portion of the web page comprises a database profile section and at least one of a news feed section, a sponsor advertisement section, and a gallery section.

2. The method according to claim 1, wherein the advertising section is related to a same sport provided in a digital athlete profile section.

3. The method according to claim 1 further comprising:
providing a site navigation section that allows navigational control of a users view of the page.

4. The method according to claim 1 wherein the advertising section is at least one of an advertising banner, a video recording and an audio recording.

5. The method according to claim 1 wherein the contacts section displays at least one of a name, email address and telephone number of the athlete for an authorized user.

6. The method according to claim 2 wherein the news feed section contains information related to a same sport provided in the digital athlete profile section.

7. The method according to claim 1 wherein the web page further comprises:
a sponsor portion configured for advertising to the user.

8. The method according to claim 1 wherein the step of accumulating the database of athlete information is accomplished through accepting user input.

9. The method according to claim 8 wherein the user is registered.

10. The method according to claim 1 further comprising:
registering one of an athlete and a team for access to the web page before the step of accumulating the database of athlete information.

11. The method according to claim 2 wherein the digital athlete profile is configured to allow the user to customize the web page with personal information.

12. The method according to claim 10 wherein the step of registering the athlete requires an athlete to submit information to the database.

13. The method according to claim 1 further comprising:
saving the internet sports social network web page.

14. The method according to claim 13 further comprising:
granting access to the internet sports social network web page for the athlete to individuals defined by the athlete.

15. The method according to claim 11 wherein the digital athlete profile is configured to allow the athlete to upload at least one of photos and video into the web page.

16. The method according to claim 1 wherein at least one of the first, second and third portions of the web page is a separate scrollable window.

17. The method according to claim 1 wherein viewing the discussions section of the web page requires authorization from the athlete.

18. The method according to claim 1 wherein the news feed section is in RSS type.

19. A method of creating an internet sports social network web page, comprising:
registering a user for network access;
accumulating a database of athletic information from the user; and
preparing the web page based on information received from the accumulation of the database information from the user, wherein at least one portion of the web page is an athletic profile section.

20. The method according to claim 19 wherein the web page includes an advertising section based upon the database of the athletic information from the user.

21. The method according to claim 19 further comprising:
saving the web page in a computer arrangement.

22. The method according to claim 19 further comprising:
granting access to the web page by the athlete to individuals defined by the athlete.

23. The method according to claim 20 wherein the advertising section is at least one of an advertising banner, a video replay and an audio replay.

24. A method of creating an internet sports social network web page comprising:
preparing a web page template, the template having a digital athlete profile portion, a gallery portion and an advertising section;
preparing a database of athletic information based on the template; and
populating the template based upon the database of athletic information to form the web page.

25. The method according to claim 1 wherein the community database includes at least one of sports statistics, school information, athlete contract information, athletic biographical information, athlete academic information, athletics awards, athletic news and athletic pictures, game videos, highlight videos, coach recommendations, teacher recommendations, activities information, community service information.

26. The method according to claim 1 further comprising:
registering an individual to access the web page created; and
displaying non-private sections of the web page created to the registered individual.

27. The method according to claim 26 wherein the individual is one of a college admission director and a college coach.

28. A method of creating an internet social network web page, comprising:
registering a user for network access;
accumulating a community database of digital activities information from the user; and
preparing the web page based on information received from the accumulation of the community database information from the user, wherein at least one portion of the web page is digital activities profile section.

29. The method according to claim 28 wherein the web page includes an advertising section based upon the community database of the digital activities profile information from the user.

30. The method according to claim 28 further comprising:
granting access to the internet social network web page for the user with the digital activities profile to individuals defined by the user.

31. The method according to claim 28 wherein the web page further comprises:
a sponsor portion configured for advertising to the user.

32. The method according to claim 28 further comprising:
registering an individual to access the web page created; and
displaying non-private sections of the web page created to the registered individual.

33. The method according to claim 28 wherein the web page includes a news feed section that contains information related to a same activity provided in the digital activities information.
